(19) United States
(12) Patent Application Publication
(10) Pub. No.: US 2017/0064295 A1
(43) Pub. Date: Mar. 2, 2017

(54) IMMERSIVE THEATRICAL VIRTUAL REALITY SYSTEM

(71) Applicant: Holonyne Corporation, El Segundo, CA (US)

(72) Inventors: Jon Stolzberg, El Segundo, CA (US); Richard Winn Taylor, Sherman Oaks, CA (US)

(21) Appl. No.: 15/243,292

(22) Filed: Aug. 22, 2016

Related U.S. Application Data
(60) Provisional application No. 62/207,796, filed on Aug. 20, 2015.

(51) Int. Cl. H04N 13/04; A47C 1/124; G06T 19/00

(52) U.S. Cl. CPC H04N 13/0459; G06T 19/006; A47C 1/124; H04N 5/60

(57) ABSTRACT

The technology relates to a virtual reality theater. The virtual reality theater may comprise an elliptical solid state stereoscopic display system and a set of seats. The stereoscopic display may include a display side and a back side and the set of seats may be positioned such that the seats have an unobstructed line of sight to the display side of the stereoscopic display system. The stereoscopic display may include a top and a bottom, and the set of seats may be positioned between the top and the bottom of the stereoscopic display system.

### BACKGROUND

There are a variety of methods for presenting three-dimensional (“3D”) stereoscopic immersive video for individual consumption which require the user to wear some sort of head-mounted display system and head-motion tracking device to experience the 3D virtual reality (“VR”) effects or which require expensive projection systems. Regarding head-mounted VR displays, a user must physically move their head around to see different parts of the experience since their viewing window is restricted to the rectangular shape provided by the display device. Long term viewing with these types of systems may cause discomfort, such as headaches and neck pain, leaving the user tired and sore from wearing the heavy head gear. Further, many users may experience visual discomfort referred to as “VR sickness” that results from imperfectly synchronized signals going to the left and right eyes.

The cost of provisioning and maintaining head-mounted virtual reality displays for usage in out-of-home venues may be prohibitive as the number of users increase. In this regard, the upkeep, repair costs, and replacement costs may rise exponentially as more head-mount VR displays are provided to users. Additionally, the head-mounted virtual reality displays may obstruct or otherwise prevent the social and cultural experiences provided by being part of an audience in a traditional theatrical setting. These factors limit the financial, theatrical, and aesthetic viability of head-mounted VR displays for the distribution of long and short form narrative entertainment, such as movies, television, and plays.

Projection systems currently in use in the marketplace may provide a stereoscopic three-dimensional experience in theatrical, themed entertainment, and simulator settings. However, projection based systems are limited in brightness and contrast, and require complex digital and optical systems to merge multiple projectors into a single image with perfect geometric alignment and color balance. Further, placement of the projection systems, particularly in a theatrical setting, such as a movie theater, may require long throw distances (i.e., the distance between the projector and the screen on which the projector projects an image.). As such, projection systems may create high levels of noise and heat, making placement of the projectors within the theatre problematic. Long-term cost of ownership and maintenance of the projection systems may become exceedingly expensive as the need to hire specialized workers to periodically replace lamps, light engines and other components of the projection systems is required. High levels of energy consumption by the projection systems may further raise the cost of ownership of the projection systems.

Stereoscopic projection systems for small scale user groups also suffer from high maintenance costs and energy usage. Small scale stereoscopic projection systems often require the viewers to wear specialized, active glasses to create a stereoscopic effect. The active glasses are typically battery powered electronic devices with shutter technology that alternatively makes each lens opaque in perfect sync with the projection device. One or more local transmitters may be required to provide a sync signal from the projection device to each pair of glasses to maintain a synchronized shuttering to provide the 3D experience. It is impractical and expensive to use active glasses in a theatrical setting as maintaining fully charged, clean glasses for consecutive presentations requires a sufficient supply of glasses and manual labor. Further, the costs associated with loss and breakage of the glasses may be significant.

Some stereoscopic projection systems used in large audience settings may use passive glasses that use either polarization or color frequency filtration to separate left and right views of a stereoscopic presentation. These systems provide one dimensional immersion, as the images on the screen may move either straight towards or away from the viewer on one axis only. As such, a true, fully immersive 3D experience is not provided.

Accordingly, there is a need for a solid state passive stereoscopic fully immersive theatrical virtual reality system which provides an immersive 3D experience while being affordable and energy efficient.

### SUMMARY

Embodiments within the disclosure relate generally a virtual reality theater. One aspect may include an elliptical solid state stereoscopic display system including a display side and a back side and a set of seats. The set of seats may be positioned such that the seats have an unobstructed line of sight to the display side of the stereoscopic display system.

In some embodiments the set of seats may be positioned between co-vertex of the stereoscopic display system. The stereoscopic display may include a top and a bottom, and the set of seats may be positioned between the top and the bottom of the stereoscopic display system. The set of seats may include two or more rows of seats, such that a first row of seats is positioned above a second row of seats and the first row of seats may have an unobstructed line of sight to the bottom of the stereoscopic display. The set of seats may be mounted on a moveable seating platform and the set of seats may move in a predefined manner during a presentation on the stereoscopic display.

In some embodiments the stereoscopic display may have a pitch of around 0.95 mm. The stereoscopic display may be a passive, high resolution, high frame rate, large scale, polarizing LED-based display.

In some embodiments the virtual reality theater may further include an immersive audio system. The 10, wherein the immersive audio system may provide audio content during a performance and the audio content may be synced to video content being presented on the display. The syncing of the audio and video content is performed by a master control system.

In some embodiments the virtual reality theater may further include a moveable robotic stage for positioning one or more live actors during a performance. The immersive audio system may audio content during a performance and the audio content may be synced to video content being presented on the display and the position of the moveable robotic stage may be adjusted throughout the performance according to predefined position data. The syncing of the audio and video content and the position of the moveable robotic stage may be performed by a master control system.

In some embodiments the virtual reality theater may further include one or more cameras for capturing movements of one or more live actors. The motion capture system may convert the movements of the one or more live actors to generate data that controls one or more virtual characters appearing on the display during a performance.

In some embodiments the virtual reality theater system may further include one or more projectors which project visual content onto a screen. The one or more projectors may be configured to map video of 3D textures onto architectural features within the theater or onto bodies of one or more live performers.

In some embodiments the virtual reality theater system may be portable.

### BRIEF DESCRIPTION OF THE DRAWINGS

The foregoing aspects, features and advantages of the present invention will be further appreciated when considered with reference to the following description of exemplary embodiments and accompanying drawings, wherein like reference numerals represent like elements. In describing the exemplary embodiments of the invention illustrated in the drawings, specific terminology may be used for the sake of clarity. However, the aspects of the invention are not intended to be limited to the specific terms used.

FIG. 1 is an illustration of an elevated left side, front view of a virtual reality system according to aspects of the disclosure.

FIG. 2 is a diagram of a virtual reality system and additional components according to aspects of the disclosure.

FIG. 3 is an illustration of an elevated right side, back view of a virtual reality system according to aspects of the disclosure.

FIG. 4 is an illustration of a top view of a virtual reality system according to aspects of the disclosure.

FIG. 5 is an illustration of an angled display of a virtual reality system according to aspects of the disclosure.

FIG. 6 is an illustration of a seating arrangement of a virtual reality system according to aspects of the disclosure.

FIG. 7 is an illustration of a schematic diagram of a top view of a studio immersive theatrical virtual reality system according to aspects of the disclosure.

FIGS. 8A and 8B are additional illustrations of the studio immersive theatrical virtual reality system according to aspects of the disclosure.

FIG. 9 is an illustration of a back view of a studio immersive theatrical virtual reality system including projectors according to aspects of the disclosure.

### DETAILED DESCRIPTION

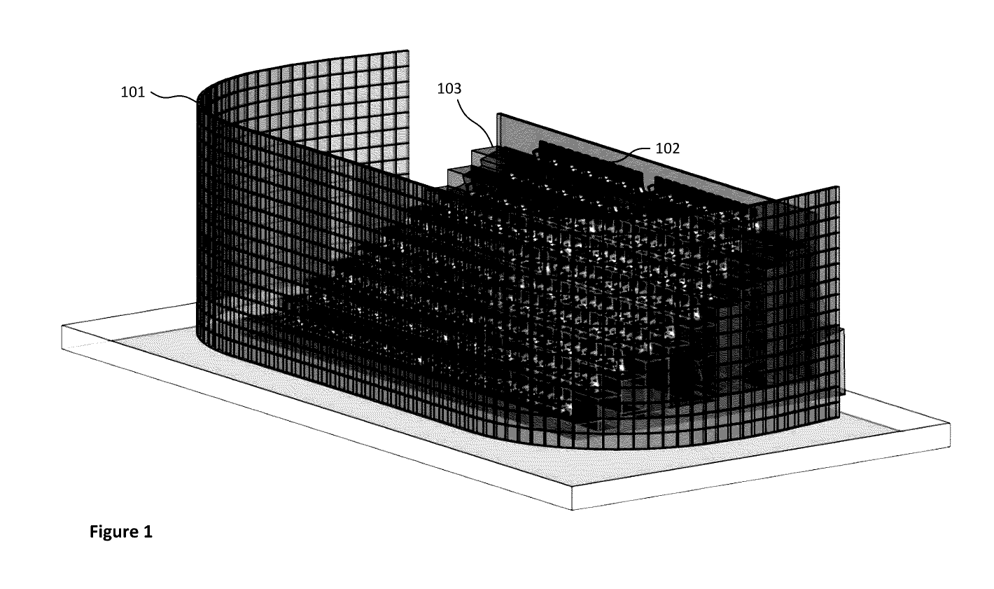

This technology relates to, by way of example, an immersive theatrical virtual reality system (the “virtual reality system”). As shown in FIG. 1, the virtual reality system may include a theater setup including a display 101, seating platform 103, and seating 102. Users may be seated within the seating 102, and virtual reality content may be presented to the users (i.e., audience) on the display 101.

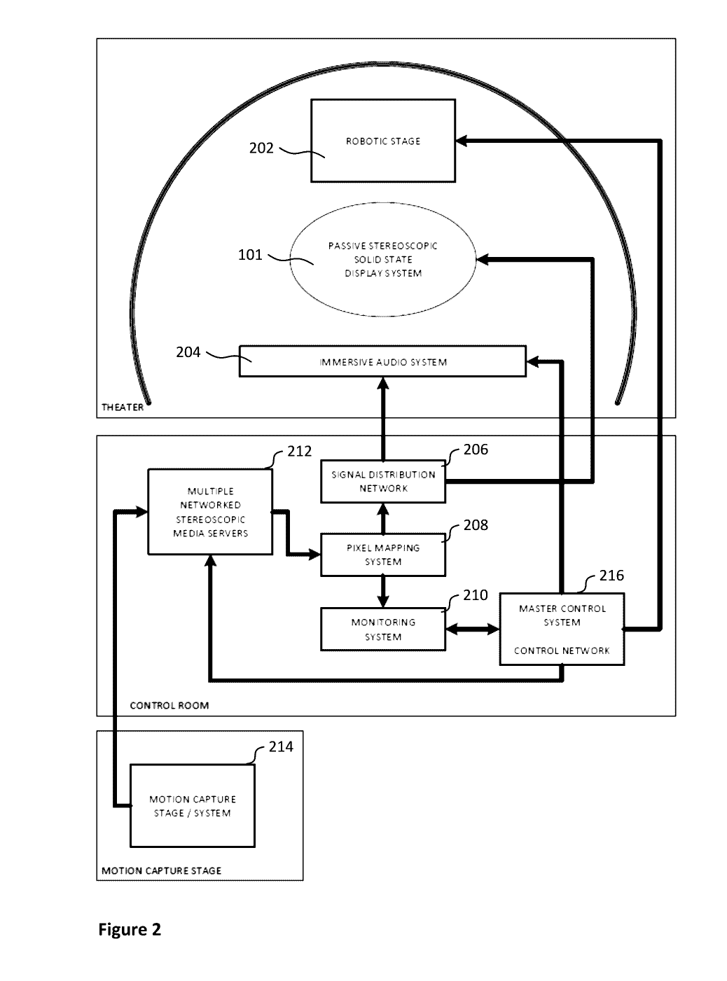

In some embodiments the virtual reality system may include supplemental components. As shown in FIG. 2, the supplemental components may include a robotic stage 202, an immersive audio system 204, a signal distribution network 206, a pixel mapping system 208, a monitoring system 210, one or more than one networked stereoscopic media servers 212, a motion capture system 214, a network/master control system 216, etc. The virtual reality system and the supplemental components may be communicatively coupled to each other coordinate the theatrical content so users are provided with a fully immersive theatrical experience.

The content provided by the virtual reality system may include computer generated content which may be presented on the display 101. Such computer generated content (i.e., virtual reality content) may include two-dimensional and/or three-dimensional video content.

The virtual reality system may also provide a combination of virtual reality content and live action performances. The live action performances may be provided by live actors such as human performers, robots, puppets, and other such tangible objects typically used in visual performances. In one example, the virtual reality system may present “virtual live” content. Virtual live content may be generated by off-stage live actors within a motion capture system 214. In this regard, the live actors may perform on a motion capture stage positioned in front of real-time motion capture system 214 and, in some cases, away from the audience's view. The motion capture system may include cameras or other such sensors which may track the movements of the live actors to generate data that controls virtual characters appearing within the virtual environment.

In another example, the virtual reality system may present “mixed reality” content. Mixed reality content may include virtual reality content which may be presented in combination with performances by live actors such that the virtual reality content is seamlessly merged with live actor's performances. In this regard, the live actors may be positioned on a stage within the theater, such as a robotic stage 202. The robotic stage 202 may be positioned in front of the display 101, such that the live actor is in the line of view of the audience members. The positioning of the live actor by the robotic stage 202 may be controlled by a master control system 216, such that the live actor is automatically moved to the appropriate position during a performance. In some embodiments the robotic stage 202 may move the actor in three-dimensions. The live actors may be positioned in stationary positions around the theater, such as on the theater's floor. The robotic stage 202 may be lowered into the floor when not in use during a performance.

The robotic stage may be outfitted with one or more display surfaces that enable live actors to perform in the theater and appear within the virtual environment. For instance, the robotic stage 202 may be moved during a performance as the stage's display surface displays video content. As such, the robotic stage may become part of the existing virtual environment.

The visual content, such as the virtual reality video content and live action visual performances may be presented to the audience with audio. The audio may be transmitted to the audience via an immersive audio system 204. The immersive audio system may include speakers, subwoofers, horns, and other such sound transmitted devices. The audio may be synchronized to the virtual reality and live action performances. In this regard, the audio may be pre-programmed and transmitted to the audience at scheduled times. In some embodiments audio may be captured by microphones attached, or positioned around, the live actors on the motion capture stage, the robotic stage 202, or elsewhere, such as on the floor of the theater.

Production and post-production techniques may assist the virtual reality system with providing an immersive virtual world to the audience. As previously described, the virtual reality system may include a robotic stage for integrating live performers within the virtual environment generated by the display, to create a mixed reality. Further, the virtual reality system may include hardware configurations and the use of specific multi-media design and production techniques to further enhance the 3D environment. For example, the seating platform 103 of the virtual reality system may include motors to move the platform during a performance. Additionally, 2D or 3D films that are formatted for traditional displays can be played back on the display and incorporated into the virtual environment.

The transmission and distribution of the virtual reality content to the display and the audio to the immersive audio system may be controlled by systems outside of the theater, such as in a control room. For instance, a control room may include a signal distribution network 206, a pixel mapping system 208, a monitoring system 210, and/or one or more networked stereoscopic media server 212. These systems may be controlled and monitored by a master control system 216.

The signal distribution network may comprise hardware and software commutatively coupled to the display system 101 and the immersive audio system 204 to provide audio and video content to the audience. For example, the signal distribution network may include streaming software which controls the audio and video content delivery to the display system 101 and the immersive audio system 204, respectively. The signal distribution network delivers the audio and video content via wired or wireless connectors, such as HDMI, coaxial, RCA, XLR, Wi-Fi, Bluetooth, or other such connections.

The audio and video content may be provided by one or more networked stereoscopic media servers, such as stereoscopic media server 212. In this regard, the stereoscopic media servers may store pre-programmed audio and video content. The pre-programmed audio and video content may be output to the pixel mapping system 208 and ultimately output on the display 101 and immersive audio system 204, respectively.

The stereoscopic media servers may also be connected to the motion capture system 214. In this regard, the stereoscopic media servers 212 may receive the video and audio data generated by the live actors. The stereoscopic media servers 212 may process the received audio and video data and incorporate it into the pre-programmed audio and video content. In this regard, the stereoscopic media servers, in conjunction with the master control system 216 may include a scan conversion and decoding matrix to access and convert the received audio and video data with the stored audio and video content. The decoding matrix may merge the sources with file-based content from internal media servers to produce a coherent output. The combined content may then be output to the pixel mapping systems 208, as previously described. In some embodiments the stereoscopic media servers may render the audio and video content in real time.

The stereoscopic media servers may store the audio and video content in storage. Such storage may include one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

The pixel mapping system may aggregate the audio and video content from the one or more than one networked stereoscopic media server. In this regard, the pixel mapping system may receive multiple streams of audio and video content such that the multiple streams are matched in accordance with the performance requirements. For example, the multiple streams of video may correspond to different portions of the display. As such, the pixel mapping system may assure the signals sent to the display accurately provide the multiple streams of video content at the appropriate portion of the display 101.

A monitoring system may monitor the status of the display, immersive audio system, and supplemental components. In this regard, the monitoring system may continually track the status of the components in the theater, as well as the supplemental components which may be in a separate control room. In the event the monitoring system 210 detects an error in the status of one or more components, a signal may be transmitted to the master control system 216. For example, should the pixel mapping system sense the video content is not synced to the audio content, an error may be detected by the monitoring system 210 and a signal may be sent to the master control system 216.

The master control system may control all media servers, signal switches, signal processors and signal extenders and synchronizes media playback with all other devices within the virtual reality system. Further, the master control system 216 may control the robotic stage, the immersive audio system, and the one or more than one networked stereoscopic media server so that the visual and audio performance is produced without errors. In this regard, the master control system 216 may control when the one or more stereoscopic media servers deliver content to the pixel mapping system 208. In addition, the master control system 216 may control the volume and output of the audio content, as well as the positioning of the robotic stage. In some embodiments, the master control system 216 may be programmed to automatically control the presentation of the audio and video content during the visual performance. Further, the master control system 216 may control lighting, robotics, rigging, interactivity, and any other components that may be part of a performance.

In some embodiments the master control system 216 may also have a robust, secure data-switching network with failsafe redundant components to enable continuous secure operation, where the network is optimized to handle high volumes of multi-media traffic and data from internal and external sources. Additionally, a network of interactive devices, such as hand-held devices controlled by the live actors or permanently installed in the audience-seating environment. Real-time data collected from these devices enables interactive control of the media system by live performers and/or the audience.

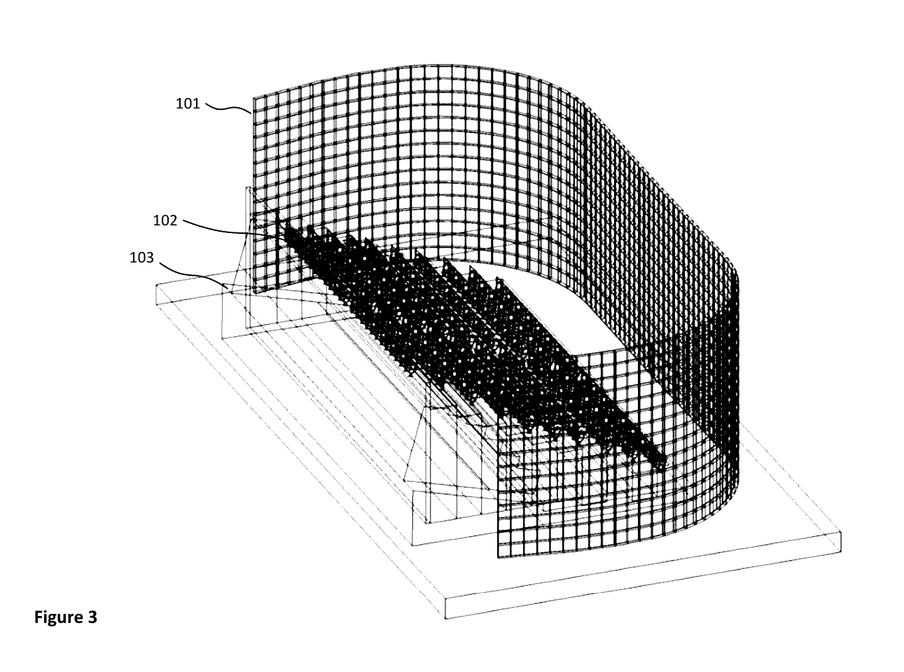

Referring now to FIG. 3, there is shown an oblique, back-left view of a virtual reality system. The seating of the virtual reality seating 102 may be arranged such that the display at least partially surrounds all of the seats. The arrangement of the seats may be dependent upon the resolution, shape, and size of the display. As described in detail herein, the seating platform 103, upon which each individual seat may be angled such that one user does not block another user's line of site to the display. As such, each user may be provided with a full or nearly full view of the display, thereby allowing each user to receive a fully immersive theatrical experience. Additionally, the virtual reality system may be scalable from small simulators for individual or small group use, up to arena-sized venues for large audiences.

The display of the virtual reality system may include passive, high resolution, high frame rate, large scale, polarizing solid state LED-based display technology. As illustrated in FIG. 3, the display 101 may wrap fully or partially around the seating 102. Although the display 101 is illustrated as multiple individual components, the display may be one continuous unit. The display may be manufactured such that the content output from the display may include stereoscopic separation of left-eye and right-eye signals. The height of the display may be determined by the depth of the seating and the angle of the seating. In this regard, the display may extend above the highest row of seats and below the lowest row of seats. In some embodiments the display may be 100 feet tall, or more or less. Although not shown, the system may also include one or more projectors capable of outputting stereoscopic video. Such projectors may run through a video mapping system which may provide instructions to map video of 3D textures, or other video content, onto architectural features within the theater environment, or onto practical props and physical stage pieces, or onto the bodies or costumes of live performers in both the virtual live and mixed reality modes of the system. This adds an additional layer of texture to the virtual reality experienced by the audience.

Each user may be provided with passive stereoscopic viewing glasses which may deliver the left-eye and right-eye signals to their left and right eyes, respectively. When the users view the content through the passive viewing glasses they may experience an environment that delivers content on three axes: (x,y,z) to create a fully immersive high definition photo-realistic, 3D environment. As such, the users may be transported from the physical space of the theater and placed within the space of the virtual world.

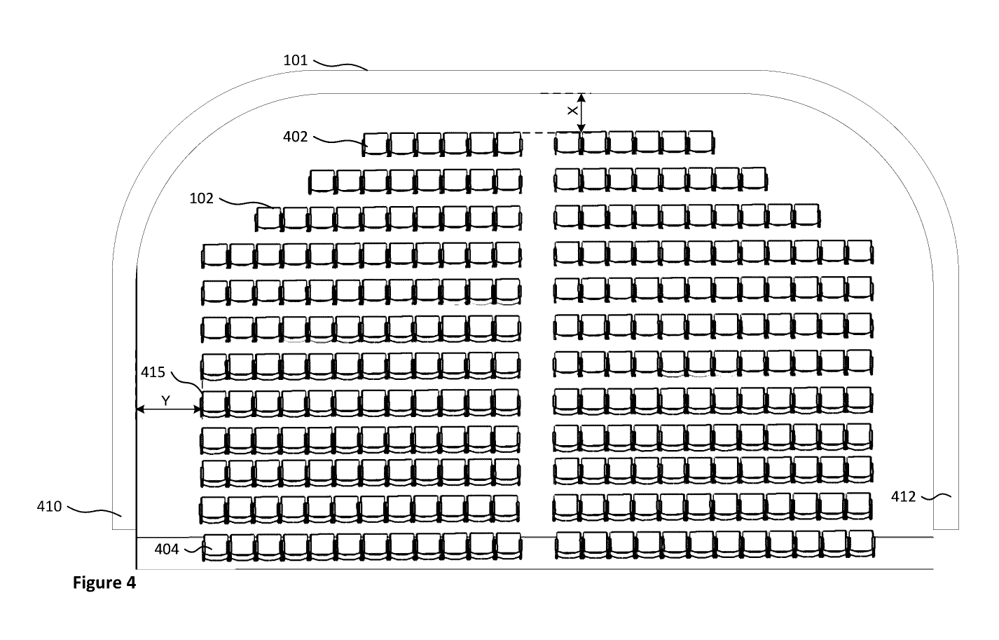

As shown in FIG. 4, the width of the display extends beyond the audience seating. In this regard, display 101 may be elliptical in shape and the seats 102 may be positioned between the co-vertex 410 and 412 of the display. In some embodiments, not all seats may be within the co-vertex of the display 101, such as row 404 in FIG. 4. The width of the display may be a function of the number of seats across that the theater has. Optionally, there can be an additional solid state stereoscopic display attached to the ceiling of the theater for a more complete immersive experience.

The positioning of the seats 102 may be based upon the pitch (i.e., the distance from one pixel to another) of the display. The smaller the pitch, the smaller the distance ‘X’ the front row of seats 402 may be from the display 101. Likewise, the seats on the side of the theater, such as seat 415, may be a distance ‘Y’ from the display 101, depending upon the pitch of the display. In some embodiments the pitch of the display 101 may be 0.95 mm, or more or less.

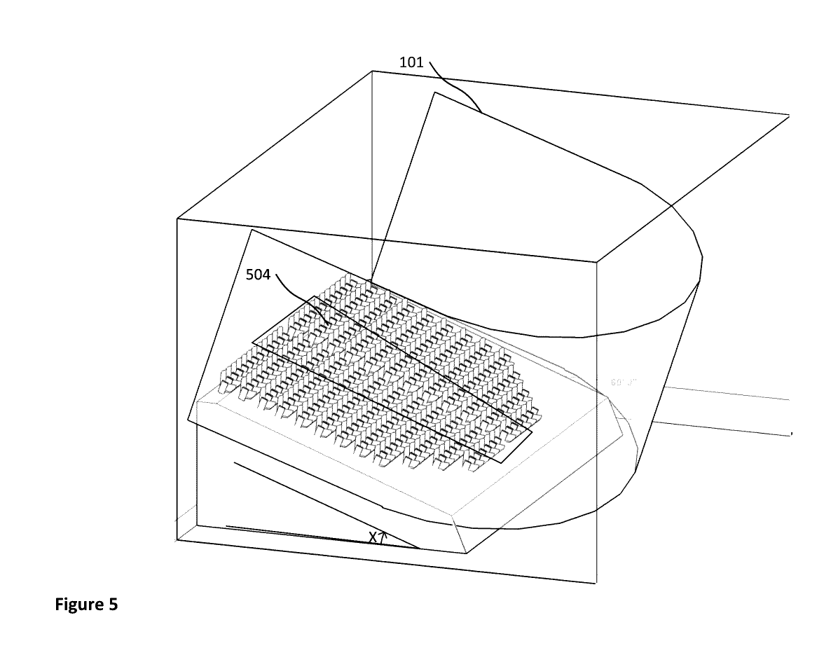

As illustrated in FIG. 5, the display may be angled to assist the users in the middle section of the seating see the bottom of the display. For instance, display 101 may be angled ‘X’ degrees, which may be anywhere between 0-45 degrees, or more or less. As such, users sitting in seats in the middle section 504 may see the bottom of the display 101.

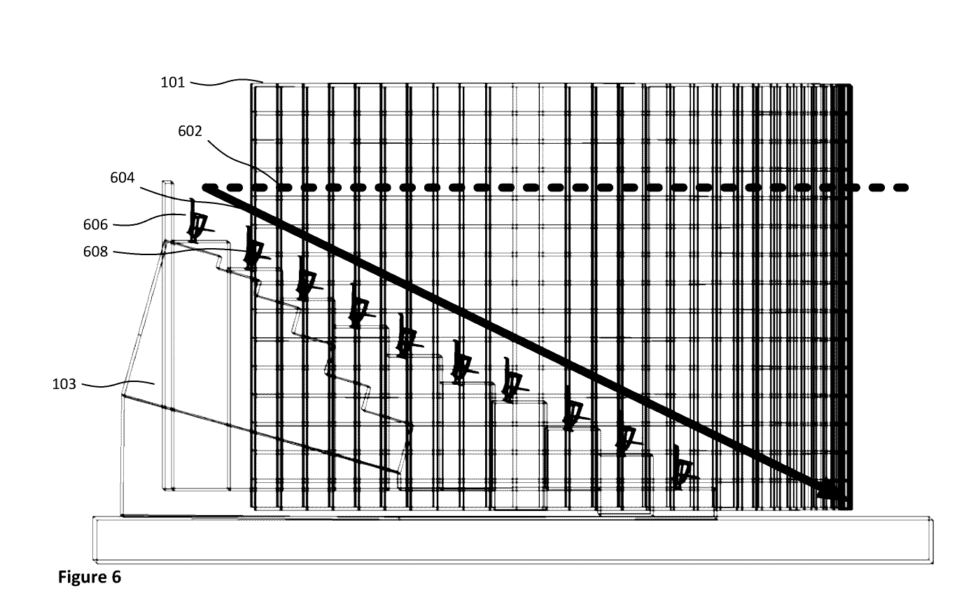

The seating may be arranged on an angled seating platform to provide each row of seats with a view of nearly the entire display. In this regard each row of seats, such as row 606, may be positioned such that they are sufficiently higher than the row of seats below, such as row 608, as shown in FIG. 6. As such, the users sitting in row 604 may be able to see the portions of the display 101 below their line of view 602. In some embodiments the rows of seats may be positioned such that the downward line of view 604 of users in a row may include the bottom of the display 101. As previously discussed, the seating platform 103 of the virtual reality system may include motors to move the platform during a performance thereby raising or lowering one or more seats or rows of seats, as well as increasing or decreasing the angle of the seats.

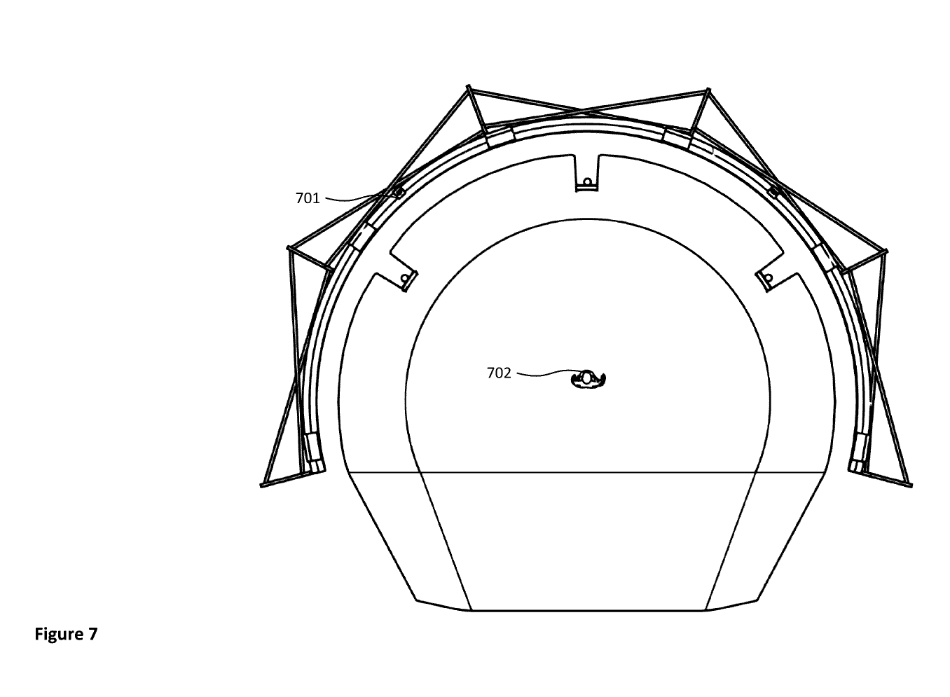

Referring now to FIG. 7, there is shown diagram of a schematic diagram of a top view of the studio immersive theatrical virtual reality system according to another embodiment. The solid state stereoscopic display 701 of the studio immersive theatrical virtual reality system may surround one or more users, such as user 702. In this regard, the display 701 may surround the user 210 degrees or more or less in order to make the VR experience fully immersive. The studio immersive theatrical virtual reality system may be used in both the virtual live and mixed reality modes, as previously discussed. Further, stages and other such elements may be added to the system. The screen radius may be determined by based on the pitch size of the display, as well as the size of the space and the number of audience members that can be safely admitted to view the show.

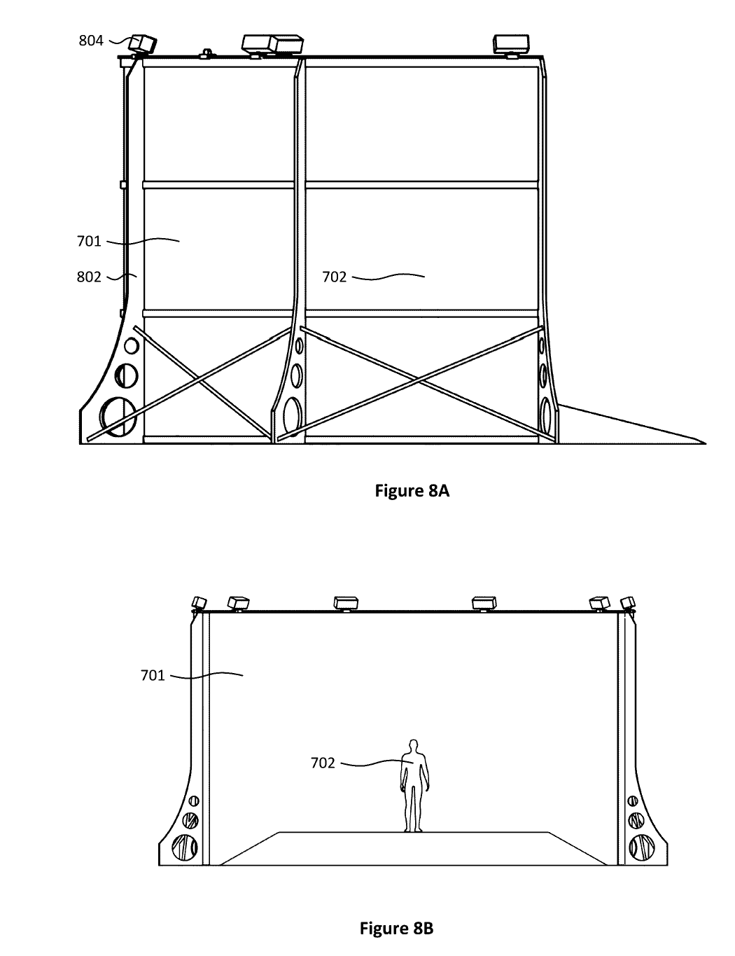

Referring now to FIGS. 8A and 8B, there is shown schematic diagrams of a side and back view of a studio immersive theatrical virtual reality system, respectively. As illustrated in FIGS. 8A and 8B, a lighting grid 804 may be positioned over the display 701 and user 702. Other equipment, such as sound, projection, automation, may also be provided to further enhance a traditional VR experience, as previously described. As can be further seen, the immersive theatrical virtual reality system can be made portable or sized to fit smaller venues that normally could not accommodate a traditional VR system. In this regard, the immersive theatrical virtual reality system may be supported by portable, lightweight supports 802. In some embodiments the immersive theatrical virtual reality system can be scaled to fit into a home, bringing the experience to a more personal level. Although not shown, the studio immersive theatrical virtual reality system may include moveable seating.

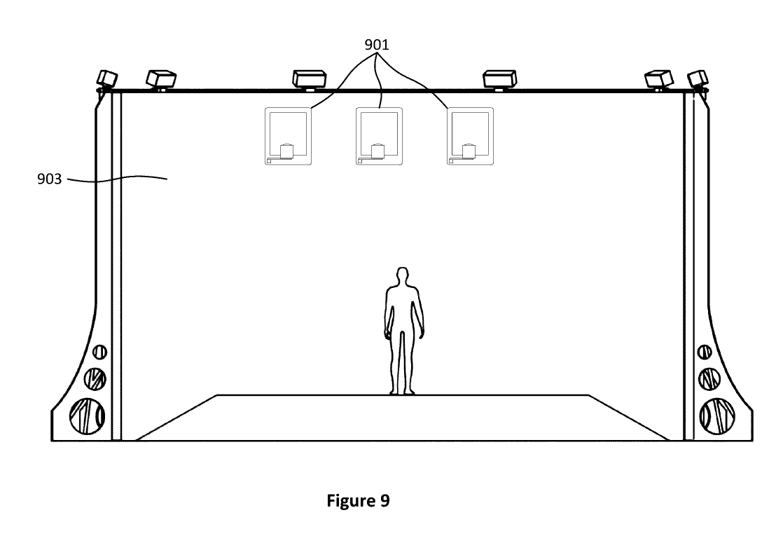

Referring now to FIG. 9, the studio immersive theatrical virtual reality system may include one or more rear projectors 901. The overhead projection system may project images onto a screen 903. As such, the overhead projection system may supplement or compliment the solid state stereoscopic display. Although the studio immersive theatrical virtual reality system with rear projectors 901 may include movable seating, without movable seating and/or a stage, the system may very portable while providing a fully immersive virtual reality. As such, this embodiment may be useful for portable applications such as trade shows, open, houses, visitor centers and other venues where grabbing the attention of a limited number of audience members at a time can add value to a venue.

All dimensions specified in this disclosure are by way of example only and are not intended to be limiting. Further, the proportions shown in the included Figures are not necessarily to scale. As will be understood by those with skill in the art with reference to this disclosure, the actual dimensions and proportions of any system, any device or part of a system or device disclosed in this disclosure are adjustable based upon the size of the virtual reality system being implemented, as described herein.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A virtual reality theater, comprising:
an elliptical solid state stereoscopic display system comprising a display side and a back side; and
a set of seats, wherein the set of seats are positioned such that the seats have an unobstructed line of sight to the display side of the stereoscopic display system.

2. The virtual reality theater system of claim 1, wherein the set of seats are positioned between co-vertex of the stereoscopic display system.

3. The virtual reality theater system of claim 1, wherein the stereoscopic display system further comprises a top and a bottom, and the set of seats are positioned between the top and the bottom of the stereoscopic display system.

4. The virtual reality theater system of claim 1, wherein the set of seats comprises two or more rows of seats, such that a first row of seats is positioned above a second row of seats.

5. The virtual reality theater system of claim 4, wherein the first row of seats have an unobstructed line of sight to the bottom of the stereoscopic display.

6. The virtual reality theater system of claim 1, wherein the set of seats are mounted on a moveable seating platform.

7. The virtual reality theater system of claim 6, wherein the set of seats may move in a predefined manner during a presentation on the stereoscopic display.

8. The virtual reality theater system of claim 1, wherein the display has a pitch of around 0.95 mm.

9. The virtual reality theater system of claim 1, wherein the stereoscopic display is a passive, high resolution, high frame rate, large scale, polarizing LED-based display.

10. The virtual reality theater of claim 1, wherein the theater further comprises an immersive audio system.

11. The virtual reality theater of claim 10, wherein the immersive audio system provides audio content during a performance and the audio content is synced to video content being presented on the stereoscopic display.

12. The virtual reality theater of claim 11, wherein the syncing of the audio and video content is performed by a master control system.

13. The virtual reality theater of claim 10, wherein the theater further comprises a moveable robotic stage for positioning one or more live actors during a performance.

14. The virtual reality theater of claim 13, wherein the immersive audio system provides audio content during a performance and the audio content is synced to video content being presented on the stereoscopic display; and
the position of the moveable robotic stage is adjusted throughout the performance according to predefined position data.

15. The virtual reality theater of claim 11, wherein the syncing of the audio and video content and the position of the moveable robotic stage is performed by a master control system.

16. The virtual reality theater of claim 1, wherein the theater further comprises one or more cameras for capturing movements of one or more live actors.

17. The virtual reality theater of claim 16, wherein a motion capture system converts the movements of the one or more live actors to generate data that controls one or more virtual characters appearing on the stereoscopic display during a performance.

18. The virtual reality theater system of claim 1, wherein theater further comprises one or more projectors which project visual content onto a screen.

19. The virtual reality theater system of claim 1, wherein theater further comprises one or more projectors configured to map video of 3D textures onto architectural features within the theater or onto bodies of one or more live performers.

20. The virtual reality theater system of claim 1, wherein theater is portable.
